(19) United States
(12) Patent Application Publication
(10) Pub. No.: US 2013/0254225 A1
(43) Pub. Date: Sep. 26, 2013

(54) DEVICE, METHOD, AND NON-TRANSITORY COMPUTER-READABLE MEDIUM FOR MEDICAL INFORMATION SEARCH

(71) Applicant: FUJIFILM CORPORATION, Tokyo (JP)

(72) Inventor: Keiji SUGIHARA, Tokyo (JP)

(73) Assignee: FUJIFILM Corporation, Tokyo (JP)

(21) Appl. No.: 13/846,765

(22) Filed: Mar. 18, 2013

(30) Foreign Application Priority Data
Mar. 23, 2012 (JP) 2012-066980

(51) Int. Cl. G06F 17/30

(52) U.S. Cl. CPC G06F 17/30522
USPC 707/769

(57) ABSTRACT

A medical information search device, including: a case database adapted to accumulate case information; a case specification section adapted to receive specification of desired case information from the case database and to acquire the specified desired case information from the case database; a key extraction section adapted to generate an extraction key from the case information acquired by the case specification section; a differential disease table adapted to accumulate extraction keys in association with differential disease search keys; a query determination section adapted to refer to the differential disease table to determine a query that is a differential disease search key associated with the extraction key generated by the key extraction section; a differential disease search section adapted to search the case database based on the query determined by the query determination section; and an output section adapted to output differential disease information.

### BACKGROUND OF THE INVENTION

1. Field of the Invention

The present invention relates to a technology of automatically searching for differential diseases based on specified case information.

2. Description of the Related Art

Japanese Patent Application Laid-Open No. 07-056947 discloses a case database and a search system in which a database that holds data such as clinical history outlines of past actual patients and medical examination information thereon is searched by using, as a search key, information indicating a medical condition feature of a patient who is under examination, and data such as clinical history outlines and medical examination information that correspond to the medical condition are extracted and displayed on a workstation. The case database includes a case search database and various order files for orders such as prescription and examination orders. The case search database holds a plurality of pieces of search information such as a disease name, a disease region and a symptom as key information and also holds a patient number, patient basic information and a medical examination summary as data information.

In Japanese Patent Application Laid-Open No. 07-085071, a morphological analysis section segments an inputted document into morphemes, and then allocates, to each morpheme, syntactic information and keyword information on a field of the information to be extracted. A parsing rule storage section stores rules for parsing an inputted statement by using syntactic information, an inter-keyword relation computation rule storage section stores rules for generating semantic structures which represent relations between keywords while controlling parsing rules with use of keyword information, and a document information extraction section performs a keyword-based analysis of a morpheme string, which is outputted from the morphological analysis section, in conformity with the parsing rules and the inter-keyword relation computation rules, and outputs a semantic structure which is made of keywords and a relation between keywords.

In Japanese Patent Application Laid-Open No. 2002-032476, a medical diagnosis support device is disclosed which includes: a storing means adapted to store a database K that associates between medical condition information on a patient's medical condition obtained without analysis of image data and disease information on a disease corresponding to the medical condition information; a medical condition information input means adapted to input medical condition information J including diagnostic findings #k, diagnostic reading findings $k, doctor's question results % k indicating such data as a patient's chief complaint and a case history, and biopsy results &k; and an output means adapted to read, when medical condition information J was inputted, disease information such as a disease name corresponding to the medical condition information J and a typical image of the disease, from the storing means and to output the disease information to an image display means.

In Japanese Patent Application Laid-Open No. 2004-5364, an image data input means inputs image data P′ on an ROI that is set within an object image, and a search means searches a case database for similar image data having a portion, which is similar in characteristics to the image of the inputted ROI image data P′, and diagnostic data relating to the similar image data, and reads these data. The search means performs a search by determining similarity in a similarity determination item selected by a selecting means. An output means outputs search result information that represents a search result by the search means to a display means, and the display means displays the search result on a monitor.

Japanese Patent Application Laid-Open No. 2004-118566 is one example of a database search system which stores electronic medical books. Electronic medical books generally refer to the contents of the medical books digitized so as to be accessible on a computer. Data such as a hyperlink that allows an access to the information on a related electronic medical book may be associated to each case data in the case database.

Japanese Patent Application Laid-Open No. 2008-245719 is one example of a technology for extracting a lesion area based on position information on an area of interest.

In “Active Appearance Models” by T. F. Coootes, G. J. Edwards, and C. J. Taylor, In Proc. 5th European Conference on Computer Vision, Springer, 1998, 2nd volume P484-P498, one example of a technology for calculating an image feature value within a region of interest is presented.

In Japanese Patent Application Laid-Open No. 07-056947, when the past medical examination information is stored in the database, text information such as a disease name and a disease region are held as a search key (query) so as to be used in a case search in the database. In the case of a system that performs a search with such text information as a query, it is necessary to use an appropriate query to find a desired case. For example, when a user desires to refer to other cases that are related to a case

A while in access to the case A, all the cases included in the search results obtained by a query used in search for the case A are not necessarily related to the case A. Accordingly, it is necessary to consider a new query. In order to follow and refer to related cases based on one case, the operation of considering a new query needs to be repeated, and this may cause deteriorated efficiency in case reference operation.

It is an object of the present invention to make it possible to perform a search in a case database system with a query automatically determined based on case information on a certain case and to make an easy reference to different cases (differentiation diseases) that are related to the certain case.

### SUMMARY OF THE INVENTION

In the present invention, a medical information search device is provided which includes: a case database adapted to accumulate case information; a case specification section adapted to receive specification of desired case information from the case database and to acquire the specified desired case information from the case database; a key extraction section adapted to generate an extraction key from the case information acquired by the case specification section; a differential disease table adapted to accumulate extraction keys in association with differential disease search keys; a query determination section adapted to refer to the differential disease table to determine a query that is a differential disease search key associated with the extraction key generated by the key extraction section; a differential disease search section adapted to search the case database based on the query determined by the query determination section; and an output section adapted to output differential disease information acquired from the case database by the search performed by the differential disease search section.

The case specification section receives specification of desired case information based on an index of the case information.

The key extraction section generates an extraction key by extracting a keyword from a text written in a natural language within the case information acquired by the case specification section.

The text includes information on findings, a definite diagnosis, or a symptom.

The key extraction section generates an extraction key by extracting image information or an image feature value registered in the case information acquired by the case specification section.

The key extraction section generates an extraction key by extracting image information or an image feature value registered in the case information from a lesion portion set in the image information.

The key extraction section generates an extraction key from information of a type specified in advance among case information acquired by the case specification section.

The type is specified by a user.

The information of the type specified in advance includes information on findings, a definite diagnosis, or a symptom.

The output section outputs, together with the case information acquired by the case specification section, a link to an output screen of the differential disease information retrieved by the differential disease search section.

The output section outputs, together with the case information acquired by the case specification section, a representative image of the differential disease information.

In the present invention, a method for medical information search executed by a medical information search device is provided which includes: a step of receiving specification of desired case information from a case database that accumulates case information and acquiring the specified desired case information from the case database; a step of generating an extraction key from the acquired case information; a step of referring to a differential disease table that accumulates extraction keys in association with differential disease search keys to determine a query that is a differential disease search key associated with the generated extraction key; a step of searching the case database based on the determined query; and a step of outputting differential disease information acquired from the case database by the search.

In the present invention, a medical information search program for causing a medical information search device to execute: a step of receiving specification of desired case information from a case database that accumulates case information and acquiring the specified desired case information from the case database; a step of generating an extraction key from the acquired case information; a step of referring to a differential disease table that accumulates extraction keys in association with differential disease search keys to determine a query that is a differential disease search key associated with the generated extraction key; a step of searching the case database based on the determined query; and a step of outputting differential disease information acquired from the case database by the search.

According to the present invention, an extraction key is generated from a certain case information, a differential disease table is referred to determine a query corresponding to the generated extraction key, a case database is searched based on the determined query, and differential disease information is outputted. As a result, different cases (differential diseases) relating to the certain case can easily be referred.

### BRIEF DESCRIPTION OF THE DRAWINGS

FIG. 1 is a block diagram showing a medical information search device;

FIG. 2 is a conceptual explanatory view of information stored in a differential disease table;

FIG. 3 is a flow chart showing differential disease search processing;

FIG. 4 is a view showing one example of displaying only a link to a display screen of differential disease information together with case information; and

FIG. 5 is a view showing one example of displaying a link to a display screen of differential disease information and a representative image of the differential disease together with case information.

### DETAILED DESCRIPTION OF THE PREFERRED EMBODIMENTS

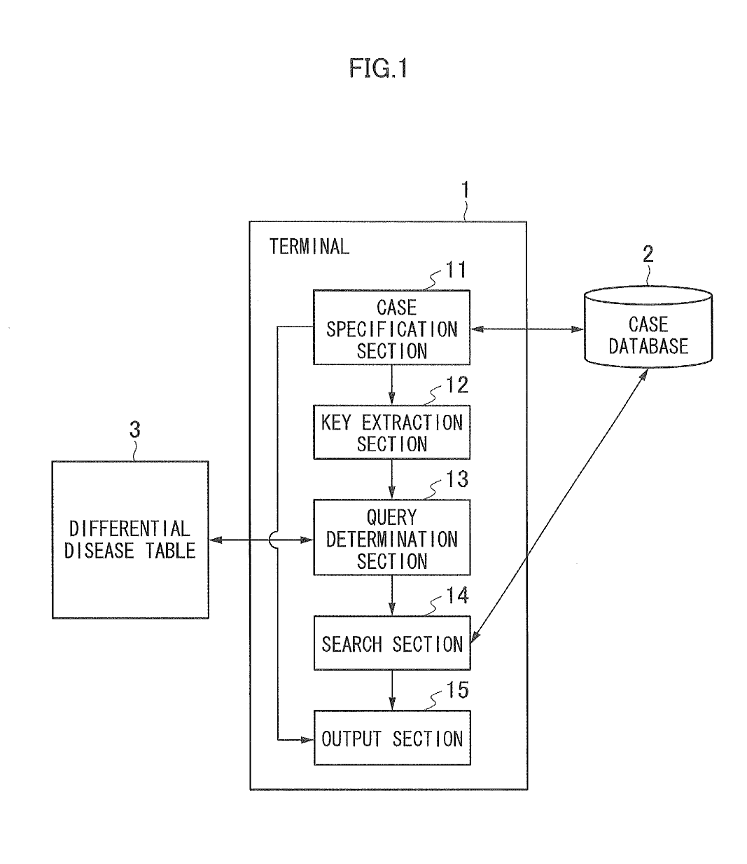

FIG. 1 is a block diagram showing a medical information search device according to a preferred embodiment of the present invention. The device includes a terminal 1, a case database 2, and a differential disease table 3.

The terminal 1 is constituted from an information processor such as a personal computer including: an arithmetic unit (CPU), a storage means (a memory device such as RAMs and ROMs, a HDD, a CD-ROM, etc.), a data input/output means (I/O), a communication means (a network adapter), a display means (a display and a display driver), and a control means (a keyboard, a mouse, a touch panel, etc.).

The case database 2 and the differential disease table 3 are constituted of the personal computer or a personal computer different therefrom, mass storage media such as a HDD in a server, and various means required for information input/output.

The case database 2 accumulates case information. The case information includes patient information such as an examination type and age, diagnostic information such as findings, a chief complaint and a definite diagnosis, image information such as a representative image, a key image and an amplification image, and feature values on the images. The case database 2 may also store medical books as in Japanese Patent Application Laid-Open No. 2004-118566.

The differential disease table 3 stores extraction keys in association with differential disease search keys. The extraction keys are obtained through the terminal 1.

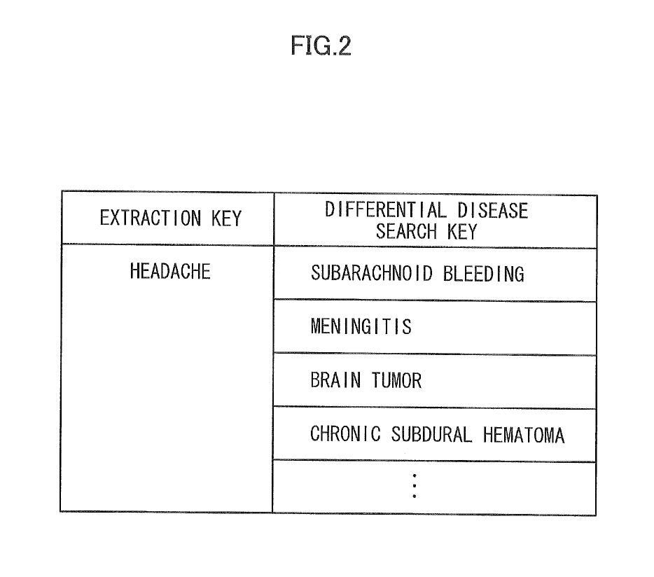

FIG. 2 is a conceptual explanatory view of information stored in the differential disease table 3. The differential disease table 3 associates extraction keys with differential disease search keys.

For example, an extraction key for a symptom of “headache” is associated with differential disease search keys such as “subarachnoid bleeding”, “meningitis”, “brain tumor” and “chronic subdural hemorrhage”. More specifically, the differential disease table 3 defines a differential disease corresponding to information (extraction keys) extracted from case information such as a symptom, a chief complaint, findings, and a feature value of image information. The differential disease means a different disease having a similar feature which requires differentiation.

Back again in FIG. 1, the terminal 1 includes a case specification section 11, a key extraction section 12, a query determination section 13, a search section 14, and an output section 15.

The case specification section 11, which is included in the control means, receives specification of desired case information among case information stored in the case database 2 by operation of a user. Specification of case information is performed by selection of items such as case by case indexes and by keyword input.

Each of the key extraction section 12, the query determination section 13, and the search section 14 is implemented by processing in the arithmetic unit.

The key extraction section 12 generates an extraction key from the case information specified from the case database 2 by the case specification section 11.

For example, an extraction key is generated by extracting a keyword from a text about findings, a definite diagnosis, a symptom and the like that are included in the case information. Keyword extraction can be performed with use of such a technology (e.g., Japanese Patent Application Laid-Open No. 07-085071) as extracting information on a specific field from a text written in natural language. In order to avoid retrieval of unnecessary information, a keyword extraction range may be limited to words with respect to a specific type, item and field, such as a symptom, so that an extraction key may be generated from the keywords with respect to an extracted symptom.

Or alternatively, an extraction key is generated by extracting image information included in the case information. For example, an extraction key is generated by automatically setting a lesion portion in an image registered in the case information through ROI (Region of Interest) analysis or the like, and extracting image information on the lesion portion and a feature value thereof (see, for example, Japanese Patent Application Laid-Open No. 2008-245719 and “Active Appearance Models” by T. F. Coootes, G. J. Edwards, and C. J. Taylor, In Proc. 5th European Conference on Computer Vision, Springer, 1998, 2nd volume P484-P498).

When a user specifies an extraction key generation range from the case information with the control means, the key extraction section 12 may extract an extraction key only from the specified case information extraction key generation range. For example, when the user excludes patient information and examination information and specifies only the information on findings, a definite diagnosis, or a symptom as the extraction key generation range, the key extraction section 12 generates an extraction key from the information on the specified findings, definite diagnosis, or symptom in the case information.

The query determination section 13 refers to the differential disease table 3 to determine a differential disease search key associated with the extraction key generated by the key extraction section 12, and sends the determined differential disease search key to the search section 14 as a query.

The search section 14 performs a case search in the case database 2 based on the query sent from the query determination section 13. Information acquired as a result of the search is sent to the output section 15 as differential disease information.

The output section 15 is constituted from a display means that outputs case information specified by the case specification section 11 and/or case information corresponding to a search result obtained by the search section 14 to a display.

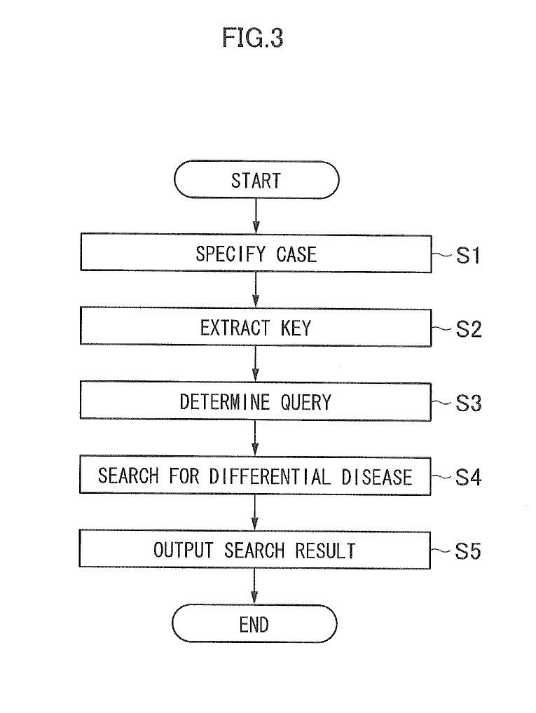

FIG. 3 shows a flow chart of differential disease search processing executed by the arithmetic unit in the medical information search device. A program for causing the medical information search device to execute this processing is stored in a storage means. In this processing, in response to specification of the case information by a user in S1, operation subsequent to S1 may sequentially be executed, or operation subsequent to S2 may be continued in response to an instruction of starting processing of a differential disease search after specification of the case information by the user in S1.

In S1, the case specification section 11 receives specification of desired case information from the user. The case specification section 11 acquires the specified case information from the case database 2 and sends it to the output section 15. The output section 15 displays the specified case information on a display.

In S2, the key extraction section 12 generates an extraction key from the case information in the case database 2 specified by the case specification section 11.

In S3, the query determination section 13 refers to the differential disease table 3 to determine a differential disease search key associated with the extraction key generated by the key extraction section 12, and sends the determined differential disease search key to the search section 14 as a query.

In S4, the search section 14 performs a case search in the case database 2 based on the query sent from the query determination section 13. Information acquired as a result of the search is sent to the output section 15 as differential disease information.

In S5, the output section 15 displays the differential disease information on a display.

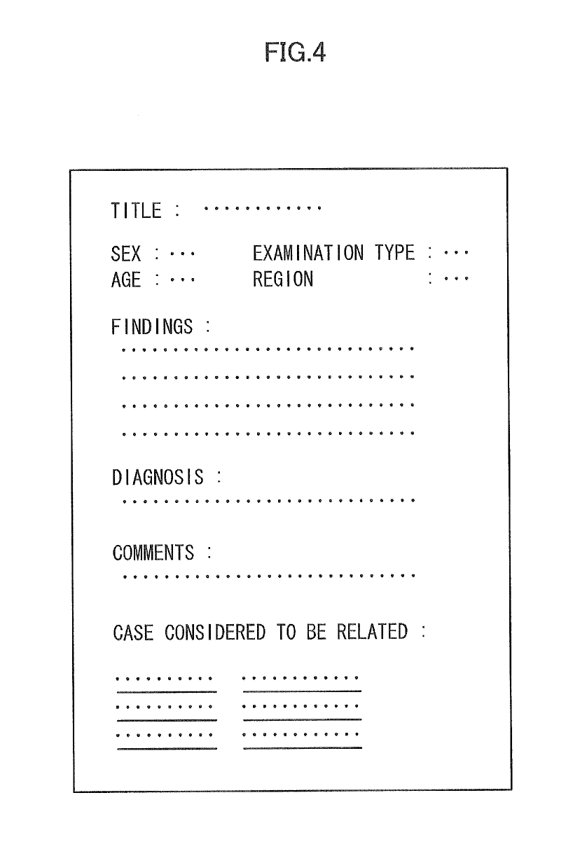

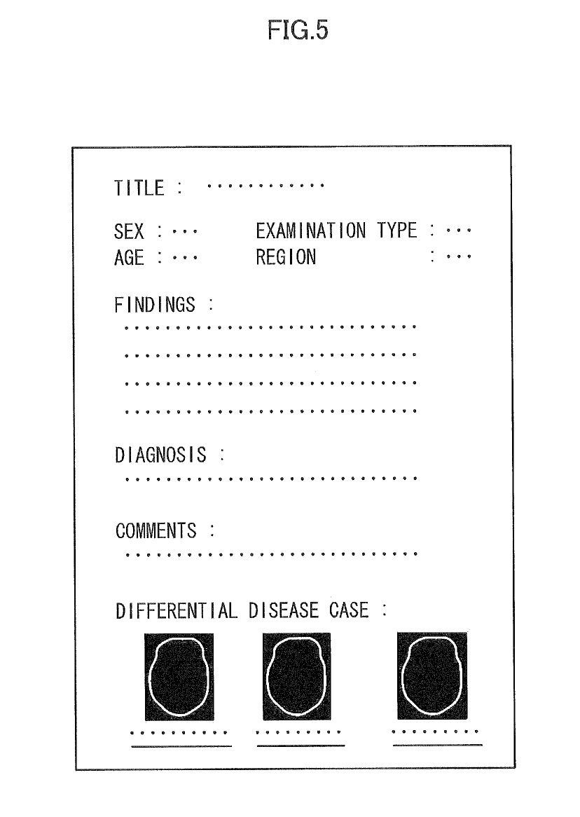

The differential disease information displayed in S5 may be displayed as a list separately from or together with the case obtained in S1. As an aspect of displaying the information together with the case obtained in S1, there may be considered an aspect (see FIG. 4 for example) which displays only a link to a display screen of the differential disease information together with the case information, or an aspect (see FIG. 5 for example) which displays a link to a display screen of the differential disease information and a representative image of the differential disease together with the case information. In both the aspects, once a user specifies a link to desired differential disease information with use of the control means, detailed information (such as findings, a symptom, a definite diagnosis and an examination image) on the specified differential disease information is acquired from the case database 2 and is displayed on a display.

Unlike the search range for case specification in S1, the differential disease search range in S5 may extensively include not only case information but also medical book data and the like. This makes it possible to increase the range of differential diseases that can be presented in association with the specified case information.

As a result of the above processing, an extraction key is automatically generated from the case information that is arbitrarily specified by the user, and a differential disease relating to the case information is retrieved and displayed. Accordingly, it becomes possible to easily and reliably perform a differential disease search relating to the case information arbitrarily specified by the user, and to present the result to the user.

What is claimed is:

1. A medical information search device, comprising:
a case database adapted to accumulate case information;
a case specification section adapted to receive specification of desired case information from the case database and to acquire the specified desired case information from the case database;
a key extraction section adapted to generate an extraction key from the case information acquired by the case specification section;
a differential disease table adapted to accumulate extraction keys in association with differential disease search keys;
a query determination section adapted to refer to the differential disease table to determine a query that is a differential disease search key associated with the extraction key generated by the key extraction section;
a differential disease search section adapted to search the case database based on the query determined by the query determination section; and
an output section adapted to output differential disease information acquired from the case database by the search performed by the differential disease search section.

2. The medical information search device according to claim 1, wherein
the case specification section receives specification of desired case information based on an index of the case information.

3. The medical information search device according to claim 1, wherein
the key extraction section generates an extraction key by extracting a keyword from a text written in a natural language within the case information acquired by the case specification section.

4. The medical information search device according to claim 3, wherein
the text includes information on findings, a definite diagnosis, or a symptom.

5. The medical information search device according to claim 1, wherein
the key extraction section generates an extraction key by extracting image information or an image feature value registered in the case information acquired by the case specification section.

6. The medical information search device according to claim 5, wherein
the key extraction section generates an extraction key by extracting image information or an image feature value registered in the case information from a lesion portion set in the image information.

7. The medical information search device according to claim 1, wherein
the key extraction section generates an extraction key from information of a type specified in advance among case information acquired by the case specification section.

8. The medical information search device according to claim 7, wherein the type is specified by a user.

9. The medical information search device according to claim 7, wherein
the information of the type specified in advance includes information on findings, a definite diagnosis, or a symptom.

10. The medical information search device according to claim 1, wherein
the output section outputs, together with the case information acquired by the case specification section, a link to an output screen of the differential disease information retrieved by the differential disease search section.

11. The medical information search device according to claim 1, wherein
the output section outputs, together with the case information acquired by the case specification section, a representative image of the differential disease information.

12. A method for medical information search executed by a medical information search device, comprising:
a step of receiving specification of desired case information from a case database that accumulates case information and acquiring the specified desired case information from the case database;
a step of generating an extraction key from the acquired case information;
a step of referring to a differential disease table that accumulates extraction keys in association with differential disease search keys to determine a query that is a differential disease search key associated with the generated extraction key;
a step of searching the case database based on the determined query; and
a step of outputting differential disease information acquired from the case database by the search.

13. A non-transitory computer-readable medium having a medical information search program for a medical information search device to execute:
a step of receiving specification of desired case information from a case database that accumulates case information and acquiring the specified desired case information from the case database;
a step of generating an extraction key from the acquired case information;
a step of referring to a differential disease table that accumulates extraction keys in association with differential disease search keys to determine a query that is a differential disease search key associated with the generated extraction key;
a step of searching the case database based on the determined query; and
a step of outputting differential disease information acquired from the case database by the search.
